(19) United States
(12) Patent Application Publication
(10) Pub. No.: US 2018/0065301 A1
(43) Pub. Date: Mar. 8, 2018

(54) Swap Platform Support with Improved Temperature Control

(71) Applicant: EOS GmbH Electro Optical Systems, Krailling (DE)

(72) Inventors: Siegfried Mayer, Kolbermoor (DE); Horst Maier, Planegg (DE)

(73) Assignee: EOS GmbH Electro Optical Systems, Krailling (DE)

(21) Appl. No.: 15/699,619

(22) Filed: Sep. 8, 2017

(30) Foreign Application Priority Data
Sep. 8, 2016 (DE) 102016217129.1

(51) Int. Cl. B29C 64/245; B29C 64/295; B33Y 30/00

(52) U.S. Cl. CPC B29C 64/245; B33Y 30/00; B29C 64/295

(57) ABSTRACT

A swap platform support for an additive layer-wise building device, which is configured to produce at least one three-dimensional object on a swap platform (121) by solidifying layer by layer a building material in powder form at positions that correspond to the at least one object in the respective layers comprises a clamping device (115, 116) for detachably fixing a position of the swap platform (121) with respect to the position of the swap platform support, a temperature control system (111) configured to supply heat energy to at least a portion of its environment and/or to remove heat energy from at least a portion of its environment and a pressing device (112) which is suited to press at least a part of the temperature control system (111) against a swap platform (121) when the swap platform is clamped in the clamping device (115, 116).

The invention is directed to a swap platform support for an additive layer-wise building device and to an additive layer-wise building device in which said swap platform support is arranged.

With additive layer-wise building devices, by means of which objects are produced layer by layer on an object support by solidifying a shapeless building material, usually the object is not produced directly on the support but on a building base arranged on the support. This has the advantage that after completion of the object it can be removed together with the base from the building container and can be separated from the base outside of the layer-wise building device. In order to prevent a shifting of the object on the support, in particular during application of a layer of the building material, on the one hand the building base is tightly screwed to the support and on the other hand a material is selected for the building base to which the bottommost layer of the object adheres well.

In particular in the case of additive layer-wise production methods in which the building material is solidified by heat supply to selective positions, a pre-heating of the building material often takes place up to a (working) temperature, which is, for example, slightly below the temperature (but can also be lower than that) at which the particles of the building material, usually in powder form, are joined together, i.e. melt at least at their surface. In order to avoid warpage of the object produced as a result of thermal stresses, DE 101 08 612 C1 proposes to adjust the temperature distribution in the powder cake within the building container by heating the walls of the building container and, in particular, by heating the building base.

DE 103 42 880 A1 addresses the problem that, when heating a building base, for example a building platform or a substrate plate, arranged on the support, the substrate plate can bend as a result of temperature gradients throughout the substrate plate so that the heat transfer from the heated support to the substrate plate is reduced. The problem occurs in particular when the substrate plate is not tightly screwed to the support but is merely latched to the support for an automatic exchangeability. To solve the problem, DE 103 42 880 A1 proposes to provide recesses in the substrate plate by which the thermal deformation of the substrate plate is reduced. By doing so, lower holding forces are required in order to hold the substrate plate on the support.

The inventors of the present application have found that when using a clamping system for holding a substrate plate and concurrently heating the substrate plate via the support, there are always air gaps between the substrate plate and the support. The reason for this is that a clamping system designed to be rigid for a precise fixing of the position of the substrate plate on the support and therefore cannot prevent gaps between the substrate plate and the support arising from slight deformations. However, air gaps between the substrate plate and the support cause the heat transfer from the temperature-controlled support to the substrate plate to be impaired, which is undesirable.

It is therefore an object of the present invention to provide for a precise arrangement of the building base on the support and also a good heat transfer between the support and the building base in the case of an easily exchangeable building base (building platform or a substrate plate) in an additive layer-wise building device.

The object is achieved by a swap platform support according to claim 1 and an additive layer-wise building device according to claim 15. Further developments of the invention are given in the dependent claims.

An inventive swap platform support for an additive layer-wise building device, which is configured to produce at least one three-dimensional object on a swap platform by solidifying layer by layer a building material in powder form at positions that correspond to the at least one object in the respective layers comprises:
a clamping device for detachably fixing a position of the swap platform with respect to the position of the swap platform support;
a temperature control system configured to supply heat energy to at least a portion of its environment and/or to remove heat energy from at least a portion of its environment;
a pressing device which is suited to press at least a part of the temperature control system against a swap platform when the swap platform is clamped in the clamping device.

According to the invention, the clamping device which fixes a predefined position of a swap platform on the swap platform support as precisely as possible does not have to provide at the same time for a good heat transfer between the swap platform support and the swap platform. Rather, the swap platform support has a pressing device which presses the temperature control system against the swap platform independently of the clamping device and thus ensures a good heat transfer. With the functional separation according to the invention, the accuracy with which the clamping device fixes the position of the swap platform is not impaired by the function of ensuring a good heat transfer. Of course, an interoperation of clamping device and pressing device is possible, however, according to the invention, the pressing device and not the clamping device ensures that the temperature control system is pressed against the swap platform, in particular perpendicular to the surface of the swap platform that faces the swap platform support.

In particular, according to the invention, not necessarily the entire swap platform support is pressed against the swap platform but only at least a part of the temperature control system, preferably said part whose surface faces the swap platform when the latter is clamped. It should also be emphasized that the temperature control system need not be a heating device which is configured to supply heat to a portion of its environment. Rather, the invention is also applicable in connection with a cooling device or a heating/cooling device configured to remove heat energy from at least a portion of its environment.

The temperature control system preferably has a number of temperature control elements, each of which is configured to supply heat to at least a portion of its environment and/or to remove heat energy from at least a portion of its environment. Hence, the individual temperature control elements can be arranged at different positions in order to heat and/or cool different regions of a swap platform differently, for example. A temporal sequence of heating and cooling, for example alternatingly or intermittently, is also possible, wherein this can also be implemented by means of a single temperature control element (but also with several temperature control elements) which can then be operated using the so-called Variotherm method. Here, the invention comprises all embodiments in which at least one of the temperature control elements is pressed against the swap platform.

Furthermore, the clamping device is preferably configured to bring into accord within a plane parallel to the layers on the swap platform a location position of a predetermined location in the swap platform with a support position of a predetermined location in the swap platform support, wherein a positional uncertainty in a direction within the plane is smaller than or equal to 30 μm, preferably smaller than or equal to 25 μm, particularly preferred smaller than or equal to 20 μm.

The present invention is particularly advantageous when the position of a swap platform relative to the swap platform support is to be fixed with high precision. In particular, an application of the invention is possible in connection with reference clamping systems in which a reference point is defined on the swap platform which serves not only as a reference point in the production of an object in the additive layer-wise building device but also serves as a reference point in further processing devices, such as in a milling device, in which the additively manufactured objects are post-processed. In such reference clamping systems an arrangement of a platform relative to the respective device with zero clearance is of great importance. A positional uncertainty in a direction parallel to the layers on the swap platform denotes the magnitude of the deviation of an actual position from a desired position in the predetermined direction. Herein, it is not relevant for the present invention whether the statistical mean of all deviations or the maximum value of the deviation is used for the evaluation. Both would be possible.

Even if it is possible to operate the clamping device and the pressing device by separate processes, the clamping device and the pressing device are preferably configured such that when in the act of clamping a swap platform at least a part of the temperature control system is pressed against the swap platform by the pressing device. Thus a swap platform can be exchanged easily despite the separation of the functions of the clamping device and the pressing device.

In a particular embodiment, the pressing device forms part of the temperature control system. As a result, the structure is simplified, for example, the temperature control system or the part thereof that is pressed against the swap platform can at least partially have an elastic encasement, preferably of high thermal conductivity.

Various implementations are possible for the realization of the pressing device. However, the pressing device is preferably an elastic element, for example one or several springs or elements made of an elastomer material, which are preferably arranged such that they press at least a part of the temperature control device against the swap platform perpendicular to the surface of the swap platform that faces the swap platform support when the swap platform is clamped in the clamping device. The pressing function can thus be realized in a particularly simple manner.

Herein, the clamping device is preferably configured to provide a connection between a swap platform and the swap platform support in such a way that in the mounted state the elastic element is compressed. For example, the clamping device is configured such that for connecting a swap platform with the swap platform support the elastic element has to be compressed so that then in the mounted state the elastic element (one or more springs, for example) presses at least a part of the temperature control device against the swap platform perpendicular to the surface of the swap platform that faces the swap platform support.

As an alternative or in addition to using an elastic element, the pressing function can also be realized by the pressing device being a pneumatically, hydraulically, electromagnetically or piezoelectrically actuated device. This has the particular advantage that the pressing function can then be automatically controlled particularly simply.

The swap platform support preferably has a swap platform support lower portion and a swap platform support upper portion, wherein at least a part of the temperature control system is arranged in the swap platform support upper portion, preferably on the upper side thereof, and the pressing device, preferably an elastic element, is arranged between the swap platform support lower portion and the swap platform support upper portion. This embodiment ensures that the abutment of the temperature control system to the swap platform is not prevented by elements of the pressing device. In addition, the pressing device does not necessarily have to act upon the temperature control system. It is sufficient for the swap platform support upper portion, together with the temperature control system arranged on the upper side thereof, to be pressed against the swap platform. As a result, it is possible to avoid heat transfer between the temperature control system and the pressing device, for example by providing a thermal insulation between the pressing device and the temperature control system which is then arranged in the upper portion of the swap platform support.

In a particular embodiment, at least a part of the temperature control system has a flexible shape, preferably a plurality of segments which are flexibly connected to one another. If at least a part of the temperature control system has a flexible shape, then this part is capable of adapting itself to a non-planar underside of a swap platform. For example, the temperature control system can consist of a plurality of flexibly interconnected segments which are pressed into depressions on the underside of the swap platform. This allows to establish an improved contact to the underside of a swap platform and to improve heat transfer.

Moreover, the temperature control system preferably has a surface which is designed so as to be parallel to the surface of the swap platform that faces the swap platform support when the swap platform is clamped in the clamping device. In particular, when the swap platform has a planar shape, the temperature control system, which is preferably at least partially arranged on the surface of the swap platform support facing the swap platform, should preferably be designed such that it is also planar at its surface facing the swap platform and is able to abut on the swap platform. The greater the portion of the surface which abuts on the swap platform, the better is the heat transfer. Therefore, the swap platform-abutting portion of the surface of the temperature control system that faces the swap platform should be at least 50%, preferably at least 60%, particularly preferred at least 80%.

The temperature control system preferably has at least one heating element, in particular a heating cartridge, as in most additive methods for a layer-wise production it is important to provide heat for the building process via the building base in order to achieve a temperature distribution as homogeneous as possible within the object to be produced and the building material surrounding it during the manufacturing process.

By detachably fastening the temperature control system to the swap platform support, the temperature control system can be exchanged in a simple manner. Owing to the presence of a pressing device, according to the invention, nevertheless, a good heat transfer to a clamped swap platform is ensured despite the temperature control system being easily exchangeable.

An additive layer-wise building device according to the invention, which is configured to produce at least one three-dimensional object on a swap platform by solidifying layer by layer a building material in powder form at positions that correspond to the at least one object in the respective layers, comprises a carrier that is vertically movable, in particular movable substantially perpendicular to the layers, on which carrier a swap platform support according to the invention is mounted or into which carrier a swap platform support according to the invention is integrated.

By means of an additive layer-wise building device according to the invention, a high positioning accuracy of a swap platform within an additive layer-wise building device as well as an optimized heat energy transfer between a carrier in the layer-wise building device and the object can simultaneously be ensured. Thus, for example, during production of the object the temperature within the object and the temperature of the building material surrounding it can be better controlled, resulting in a better reproducibility of the properties of objects to be produced. Thus, in particular, the positional accuracy of objects produced can be ensured particularly well and efficiently.

Further features and expediencies of the invention are set out in the description of exemplary embodiments with the aid of the attached drawings, of which:

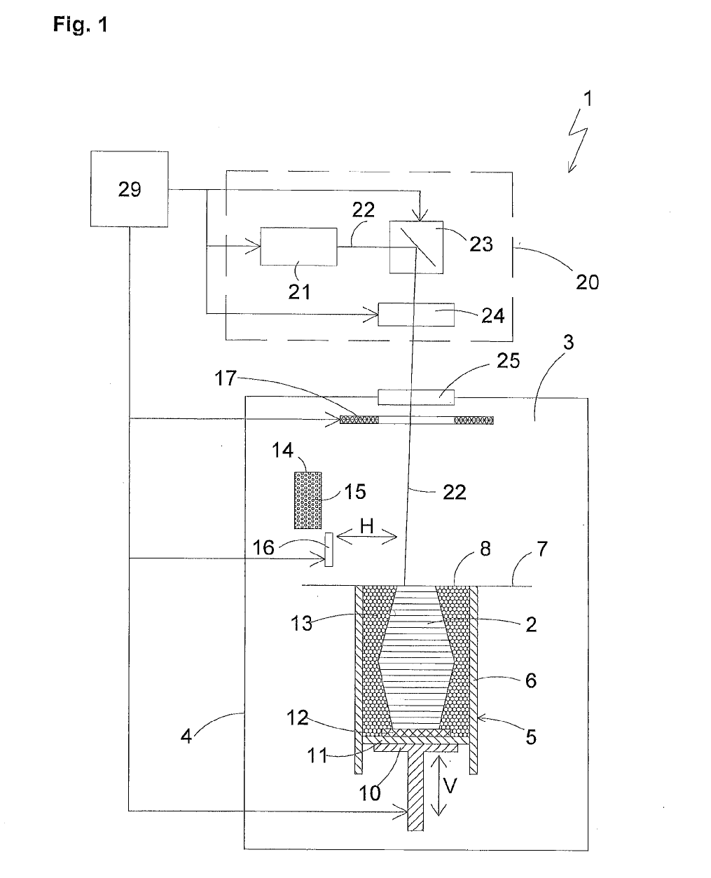

FIG. 1 shows a schematic view, partially in cross-section, of a device for additively producing a three-dimensional object according to an exemplary embodiment of the invention and

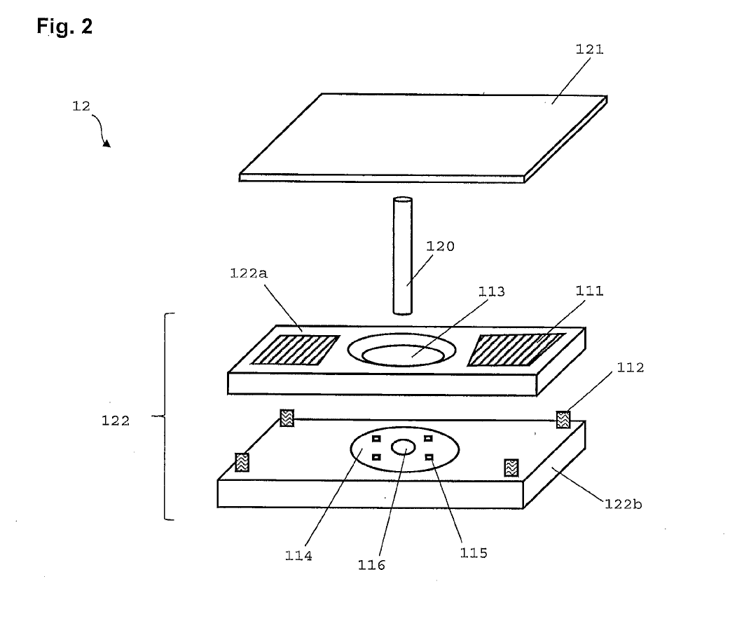

FIG. 2 is a schematic depiction of a possible embodiment of a swap platform support according to the invention, wherein the interaction with a swap platform support is depicted, too.

For a description of the invention, at first an additive layer-wise building device according to the invention will be described below with reference to FIG. 1, using the example of a laser sintering or melting device. It should be noted at this point that in the present application the term “a number of” is always to be understood as meaning “one or several”. It should also be noted that by means of an additive layer-wise building device according to the invention not only one object but also several objects can be produced simultaneously, even in those cases in which the following description only mentions one object.

For building an object 2, the laser sintering or laser melting device 1 comprises a processing chamber or building chamber 3 with a chamber wall 4.

A container 5 open to the top with a container wall 6 is arranged in the process chamber 3. A working plane 7 is defined by the upper opening of the container 5, wherein the area of the working plane 7 located within the opening, which can be used for building the object 2, is referred to as build area 8.

In the building container 5 a carrier 10 is arranged that can be moved in a vertical direction V and to which a base plate 11 is attached which seals the container 5 at the bottom and thus forms the bottom thereof. The base plate 11 can be formed as a plate separately from the carrier 10 which plate is fixed to the carrier 10, or it can be integrally formed with the carrier 10. A building base 12 on which the object 2 is built is arranged on the base plate 11. In the present embodiment, the building base 12 essentially consists of the swap platform support according to the invention and a swap platform attached thereto, the object 2 being built on the swap platform.

It should be added that in FIG. 1, the object 2 to be formed in the container 5 on the building base 12 is shown below the working plane 7 in an intermediate state with several solidified layers, surrounded by building material 13 that remained unsolidified.

The laser sintering or melting device 1 further comprises a storage container 14 for a building material 15 in powder form which can be solidified by electromagnetic radiation and an application device 16 which is movable in a horizontal direction H for applying the building material 15 within the build area 8. Optionally, a radiant heater 17 is arranged in the process chamber 3, which serves for heating the applied building material 15. As a radiant heater 17 an infrared heater can be provided, for example.

The laser sintering device 1 further comprises an exposure device 20 with a laser 21 which produces a laser beam 22 which is deflected by a deflection device 23 and focused onto the working plane 7 by way of a focusing device 24 through a coupling window 25 arranged on the upper side of the processing chamber 3 in the chamber wall 4.

Furthermore, the laser sintering device 1 comprises a control unit 29 by which the individual components of the device 1 can be controlled in a coordinated manner in order to implement the building process. Alternatively, the control unit 29 can also be partially or completely arranged outside of the device. The control unit can comprise a CPU, the operation of which is controlled by a computer program (software). The computer program can be stored separately from the device on a storage medium from which it can be loaded into the device, in particular into the control unit.

In operation, the carrier 10 is lowered layer by layer by means of the control device 29, the application device 16 is actuated to apply a new powder layer, and the deflection device 23 and optionally also the laser 21 and/or the focusing device 24 are actuated to solidify the respective layer at positions corresponding to the respective object by means of the laser by scanning these positions with the laser.

Even though in FIG. 1 a laser sintering or laser melting device was described as an example of an additive layer-wise building device, the invention is not restricted to laser sintering or laser melting. It can be applied in connection with any methods of additively producing a three-dimensional object by a layer-wise application and a selective solidification of a building material. Examples thereof include laser melting, LLM (cutting out of films and joining), FLM (application of a thermoplastic material from a nozzle), 3D printing, mask sintering and stereolithographic processes.

An exposure device can, for example, comprise one or several gas or solid-state lasers, or any other type of laser, e.g. laser diodes, in particular VCSEL (Vertical Cavity Surface Emitting Laser) or VECSEL (Vertical External Cavity Surface Emitting Laser), or an array of these lasers. In general, instead of a laser, any device can be used with which energy as electromagnetic radiation or particle radiation can be selectively delivered to a layer of the building material. Instead of a laser, for example, a different light source, an electron beam or any other source of energy or radiation suitable for solidifying the building material can be used.

Finally, it should be mentioned that the specific design of the laser sintering or melting device shown in FIG. 1 is only exemplary and can, of course, also be modified.

Various materials can be used as a building material, preferably powders, in particular metal powders, but also plastic powders, ceramic powders or sand, wherein filled or mixed powders can also be used. In particular in stereolithographic methods, photopolymers are used.

FIG. 2 shows a schematized structure of a swap platform support 122 according to the invention, which together with a swap platform 121 serves as the building base 12 shown in FIG. 1. It should be noted here that, after completion of the object, only the swap platform 121, together with the object, is removed from the building container in order to separate the object from the swap platform. Therefore, the platform 121 whose intended use is the attachment to and detachment from the swap platform support 122 is referred to as a swap platform.

In the exemplary depicted embodiment of FIG. 2, the swap platform support 122 consists of a swap platform support lower portion 122b and a swap platform support upper portion 122a. It should be noted that in FIG. 2 the swap platform support upper portion 122a and swap platform support lower portion 122b are shown separated from each other. However, in use the two portions are always connected to one another in that the tops of the spring elements 112 provided on the upper side of the swap platform support lower portion 122b are connected to the underside of the swap platform support upper portion 122a.

Furthermore, a coupling rod 120 is shown in FIG. 2 which in use is fastened to the underside of the swap platform 121. Usually it is taken out of the additive layer-wise building device together with the swap platform. Again, the coupling rod 120 is shown separately from the swap platform 121 for the sake of clarity.

The swap platform support lower portion 122b has on its upper side an attachment region 114, which serves for positioning and holding the swap platform 121 with the coupling rod 120 attached thereto. In particular, in use, the swap platform 121 with the coupling rod 120 attached thereto is inserted with the lower end of the coupling rod 120 into an engagement recess 116 in the attachment region 114 and latched there and/or held there in a force-fitting manner, the swap platform 121 thus being clamped in the swap platform support 122.

At the swap platform support 122, reference elements 115, together with the engagement recess 116 and a holding mechanism arranged therein (not shown), form a clamping system for fixing a position of the swap platform 121 with respect to the swap platform support 122. A detailed description of the holding mechanism is omitted here, as this is sufficiently well known to the person skilled in the art and is not relevant to the idea of the present invention. It is merely mentioned here that the interaction between the coupling rod 120 and the engagement recess 116 can take place according to any reference clamping system or zero-point clamping system known from the prior art. In FIG. 2, corresponding reference elements 115 for accurately fixing the position of the swap platform 121 with respect to the swap platform support 122 are shown only schematically. Such reference elements 115 serve for accurately fixing the position of the swap platform 121 in the XY plane (parallel to the plane of the swap platform 121) and/or perpendicular to said plane. It should be noted that obviously a swap platform 121 must have complementary counter-elements on its underside, which cooperate with the reference elements 115 during positioning. In FIG. 2, being merely schematic, these counter-elements are not shown. By means of a reference clamping system or a zero-point clamping system, which can be used here according to the invention, the position of a predetermined location in the swap platform (which is also referred to as a “pallet”) relative to a location in the swap platform support can be fixed, depending on the system, with an uncertainty less or equal to 30 μm, less or equal to 25 μm or less or equal to 20 μm, and ideally with an accuracy of 2 to 5 μm.

The exact number and implementation of the reference elements is known from the prior art. The company System 3R Schwciz AG, Flawil, the company STARK Spannsysteme GmbH in Götzis, Austria, as well as the company EROWA LTD in Büron, Switzerland, are mentioned as exemplary manufacturers of reference clamping systems that are implemented by means of the coupling rod 120 and the attachment region 114. The implementation of the engagement of the swap platform and the swap platform support, in particular of the coupling rod, is also known from the prior art and depends on the clamping system used.

The swap platform support upper portion 122a has a central opening 113 which is dimensioned such that through this opening the coupling rod 120 and the counter-elements on the underside of the swap platform 121 can cooperate with the attachment region 114 on the upper side of the swap platform support lower portion 122b.

Furthermore, schematically depicted temperature control elements 111 are shown on the upper side of the swap platform support upper portion 122a as a temperature control system. These temperature control elements can, for example, be heating devices, which can be implemented in various ways. For example, a temperature control element can have one or more heating conductors, however, a different type of heating device is also possible, for example, a temperature control element 111 having pipes through which a temperature-controlled fluid medium flows. It is likewise possible to alternatively or additionally provide a cooling function of a temperature control element. For example, one could let a cooling medium (e.g. water) flow through pipes in a temperature control element 111. Moreover, the two temperature control elements 111 shown in FIG. 2 are also only exemplary. There may also be a different number of temperature control elements within the scope of the invention.

In the following, insertion of a swap platform 121 into the swap platform support 122 before carrying out the production process of a number of objects in the container 5 is described exemplarily:

The coupling rod 120 attached to the swap platform 121 is inserted into the engagement recess 116 in the attachment region 114 on the upper side of the swap platform support lower portion 122b through the central opening 113 in the swap platform support upper portion 122a. By doing so, the positional accurate alignment of the swap platform 121 with the swap platform support lower portion 122b takes place by the interaction of the reference elements 115 on the swap platform support lower portion 122b with complementary elements (not shown) on the underside of the swap platform 121. In this embodiment, the spring elements 112, which connect the swap platform support upper portion 122a to the swap platform support lower portion 122b, are compressed by inserting the coupling rod 120 into the engagement recess 116. When the lower end of the coupling rod is held (fixed) in the engagement recess 116 and, accordingly, the swap platform 121 is clamped in the swap platform support 122, the swap platform 121 is positioned accurately with respect to the swap platform support 122 and at the same time the compressed spring elements 112 exert a spring force upon the swap platform support upper portion 122a from below so that said upper portion, together with the number of temperature control elements 111 on its upper side, is pressed against the underside of the swap platform 121. This ensures an excellent heat transfer between the temperature control elements 111 and the swap platform 121. Since the spring elements 112, which herein act as a pressing device, operate completely independently of how the coupling rod 120 is held and positioned in the attachment region 114, there is in particular no gap between the swap platform 121 and the temperature control elements 111 on the upper side of the swap platform support 122.

For a good heat transfer, the surface of the temperature control elements that faces the swap platform should preferably have the same spatial shape as the underside of a swap platform. In the example of FIG. 2, the surfaces of the temperature control elements 111 should therefore be as flat as possible. Here, it should be noted that, according to the present invention, the term “temperature control element” denotes a device which is configured to deliver heat to its environment or to remove heat from its environment. In addition to the heating elements already mentioned, such as heating conductors or pipes through which a fluid flows, this also includes, for example, a heating cartridge, i.e. a heating conductor in a metal cartridge as a housing. In the case that the upper surface of the swap platform support serves as a housing for a heating device, for example, when a heating conductor is integrated into the swap platform support, e.g. by pipes located near the upper surface of the swap platform support for a temperature control, that portion of the swap platform support that is used for a temperature control is to be viewed too as a temperature control element according to the invention. In the normal case, however, the temperature control element will be implemented separately from the swap platform support.

The implementation shown in FIG. 2 is merely an embodiment of the invention. Numerous modifications to this embodiment are conceivable, which can also be combined among one another if this does not lead to contradictions.

Firstly, the swap platform support does not need to be split into an upper portion and a lower portion. It would also be possible for the spring elements 112 to be disposed between the temperature control system, in particular a temperature control element, and the swap platform support 122, so that the springs 112 are compressed when the coupling rod 120 is fixed in the swap platform support 122 and serve as a pressing element for pressing the temperature control system or at least a part thereof against the underside of the swap platform 121.

Furthermore, the pressing device does not necessarily have to be formed by one or more spring elements 112. Apart from the fact that as an alternative to springs it is also possible to use elements made of an elastomer, the invention can also be implemented such that in the state in which the swap platform 121 is clamped in the swap platform support 122 at least a portion of the temperature control system is pneumatically or hydraulically pressed against the swap platform. For example, by the fixing of the coupling rod 120 in the swap platform support 122 a switch can be actuated which activates a pneumatic or hydraulic device. With the removal of the swap platform from the swap platform support, the hydraulic or pneumatic pressing force would then be deactivated, for example. Alternatively or additionally, the pressing device can also be activated and/or deactivated electromagnetically or piezoelectrically. In an extreme case, it would even be possible to fasten the temperature control system 111 or the portion of the swap platform support 122 comprising the temperature control system to the swap platform 121 by means of screws after having fixed the coupling rod 120 in the swap platform support 122. The pressing device then consists of the corresponding screws.

Although a planar swap platform is shown in FIG. 2, there are also applications in which the swap platform has a non-planar shape. For example, often not the entire object is produced by means of an additive layer-wise building method, but a part of the object is prefabricated by means of another method and by means of an additive layer-wise building method only further sections are added to the already prefabricated part of the object (the so-called preform). The preform, for example a section of an injection mold insert, is then to be considered as a swap platform which is arranged on a swap platform support. Here, it would be advantageous for the surface of the swap platform support to be adapted to the surface of the preform facing it and/or for the temperature control system to be pressed against this non-planar surface of the preform for a good heat transfer.

Furthermore, the pressing device can also be integrated into the temperature control system, e.g. by the temperature control system having an elastic element. For example, a heating conductor could have an elastic encasement, which is compressed when a swap platform is clamped in the swap platform support and provides for a pressing to the swap platform.

In the case that the swap platform 121 has a non-smooth surface (for example, a profiled surface), for example grooves, on its underside which faces the swap platform support, at least a part of the temperature control system can be configured in such a way that an interaction with this non-smooth surface is possible. For example, a temperature control element can consist of heating rods, which are flexibly connected to one another and are pressed into grooves on the underside of the swap platform when clamping the swap platform 121. The segmentation and flexible design of the temperature control system or at least a part thereof can thus be designed such that the temperature control system conforms to the surface profile of the swap platform.

It should also be noted that a plurality of swap platforms can be arrangeable on a swap platform support according to the invention, too, provided that in at least one of these a pressing of a temperature control system by means of a pressing device when the swap platform is clamped is implemented. Furthermore, it is also conceivable that a plurality of swap platform supports according to the invention are mounted on the base plate 11 in a layer-wise building device according to the invention.

A swap platform support according to the invention does not necessarily have to be mounted on the base plate 11. Rather, it can also be formed as an integral part of the base plate 11, which in turn can optionally be formed as an integral part of the carrier 10.

1. A swap platform support for an additive layer-wise building device, which is configured to produce at least one three-dimensional object on a swap platform by solidifying layer by layer a building material in powder form at positions that correspond to the at least one object in the respective layers comprises:
a clamping device for detachably fixing a position of the swap platform with respect to the position of the swap platform support;
a temperature control system configured to supply heat energy to at least a portion of its environment and/or to remove heat energy from at least a portion of its environment;
a pressing device which is suited to press at least a part of the temperature control system against a swap platform when the swap platform is clamped in the clamping device.

2. A swap platform support according to claim 1, wherein the temperature control system has a number of temperature control elements, each of which is configured to supply heat to at least a portion of its environment and/or to remove heat energy from at least a portion of its environment.

3. A swap platform support according to claim 1, wherein the clamping device is configured to bring into accord within a plane parallel to the layers on the swap platform a location position of a predetermined location in the swap platform with a support position of a predetermined location in the swap platform support with a positional uncertainty in a direction within the plane that is smaller than or equal to 30 μm.

4. A swap platform support according to claim 1, wherein the clamping device and the pressing device are configured such that when clamping a swap platform at least a part of the temperature control system is pressed against the swap platform by the pressing device.

5. A swap platform support according to claim 1, wherein the pressing device forms part of the temperature control system.

6. A swap platform support according to claim 1, wherein the pressing device is an elastic element.

7. A swap platform support according to claim 6, wherein the elastic element is formed of one or several springs, which are preferably arranged such that they press at least a part of the temperature control device against the swap platform perpendicular to the surface of the swap platform that faces the swap platform support when the swap platform is clamped in the clamping device.

8. A swap platform support according to claim 6, wherein the clamping device is configured to provide a connection between a swap platform and the swap platform support such that in the mounted state the elastic element is compressed.

9. A swap platform support according to claim 1, wherein the pressing device is a pneumatically, hydraulically, electromagnetically or piezoelectrically actuated device.

10. A swap platform support according to claim 1, with a swap platform support lower portion and a swap platform support upper portion, wherein at least a part of the temperature control system is arranged in the swap platform support upper portion, and the pressing device is arranged between the swap platform support lower portion f and the swap platform support upper portion.

11. A swap platform support according to claim 1, wherein at least a part of the temperature control system has a flexible shape.

12. A swap platform support according to claim 1, wherein the temperature control system has a surface which is designed so as to be parallel to the surface of the swap platform that faces the swap platform support when the swap platform is clamped in the clamping device.

13. A swap platform support according to claim 1, wherein the temperature control system has at least one heating element.

14. A swap platform support according to claim 1, wherein the temperature control system is detachably fastened to the swap platform support.

15. An additive layer-wise building device which is configured to produce at least one three-dimensional object on a swap platform by solidifying layer by layer a building material in powder form at positions that correspond to the at least one object in the respective layers, wherein the additive layer-wise building device comprises a carrier that is vertically movable, in particular movable substantially perpendicular to the layers, on which a swap platform support according to one of the preceding claims is mounted or into which a swap platform support according to claim 1 is integrated.
